(19) United States
(12) Patent Application Publication
(10) Pub. No.: US 2014/0047856 A1
(43) Pub. Date: Feb. 20, 2014

(54) FORWARD MANIFOLD

(71) Applicants: Eric Chrabascz, Longmeadow, MA (US); Brent J. Merritt, Southwick, MA (US)

(72) Inventors: Eric Chrabascz, Longmeadow, MA (US); Brent J. Merritt, Southwick, MA (US)

(73) Assignee: HAMILTON SUNDSTRAND CORPORATION, Windsor Locks, CT (US)

(21) Appl. No.: 13/588,440

(22) Filed: Aug. 17, 2012

(51) Int. Cl. B64D 13/02; F25D 17/06; B23P 11/00; B64D 13/08

(52) U.S. Cl. 62/241; 62/244; 165/44; 62/427; 29/525.02

(57) ABSTRACT

A manifold for an air conditioning machine includes a housing with an internal structure defining a first plenum, a second plenum, and a duct. The housing further includes a first sidewall, a second sidewall, a first end mounting face, a second end mounting face, a top sidewall, and a bottom sidewall. The housing also includes a first inlet to the first plenum, a first outlet from the first plenum, a second inlet to the second plenum, a second outlet to the second plenum, a third inlet to the duct, and a third outlet to the duct. The manifold also includes a plurality of windows, a plurality of doublers, a plurality of lugs, and a plurality of flanges.

### BACKGROUND

This invention relates generally to air conditioning machines for an aircraft, and specifically to a forward manifold for an air conditioning machine.

A typical environmental control system for an aircraft includes an air conditioning machine mounted to the outside of a pressure vessel of the aircraft. Ambient air is ingested by the air conditioning machine and is compressed by one or more cabin air compressors. The compressed air is then processed by going through primary and secondary heat exchangers and an air cycle machine. The output air from the secondary heat exchanger is typically subfreezing air with moisture, ice or snow mixed in it. The output then goes through a duct to a condenser and water collector so the moisture in the air can be condensed and removed. The air then flows through a recirculation mixer where it is mixed with recirculated air from the cabin. The mixed air then flows through an outlet into the aircraft cabin.

An aircraft air conditioning machine has to support the loads placed on it by all of the components of the machine itself, as well as stresses transferred to it from the aircraft. Stresses coming from the aircraft include stresses from take-off, landing and turbulence, and stresses from extreme temperatures. Aircraft air conditioning machines have to be built to withstand high loads and stresses while keeping the weight of the aircraft machine at a minimum.

### SUMMARY

A manifold for an air conditioning machine includes a housing with an internal structure defining a first plenum, a second plenum, and a duct. The housing further includes a first sidewall, a second sidewall, a first end mounting face, a second end mounting face, a top sidewall, and a bottom sidewall. The manifold further includes a first inlet on the second sidewall to receive air into the first plenum, a first outlet on the second end mounting face to expel air from the first plenum, a second inlet on the second end mounting face to receive air into the second plenum, a second outlet on the first sidewall to expel air from the second plenum, a third inlet on the first sidewall to receive exhaust into the duct, and a third outlet on the second sidewall to expel exhaust from the duct.

The manifold also includes a first window on the first sidewall, a second window on the second sidewall, a third window on the bottom sidewall, a first doubler on the first sidewall, a second doubler on the second sidewall having a thickness of about 0.66 cm (0.26 inches), a third doubler on the first end mounting face, a first lug on the first sidewall with a fillet radius of about 1.905 cm (0.75 inches), a second lug on the second sidewall with a fillet radius of about 1.905 cm (0.75 inches), a plurality of four lugs on the top sidewall with a fillet radius of about 1.905 (0.75 inches), a first flange on the first end mounting face with a fillet radius of about 2.54 cm (1 inches), a second flange on the first end mounting face with a fillet radius of about 1.905 cm (0.75 inches), a third flange on the first end mounting face with a fillet radius of about 1.27 cm (0.5 inches), and a fourth and fifth flange on the second end mounting face with a fillet radius of about 0.635 cm (0.25 inches).

### BRIEF DESCRIPTION OF THE DRAWINGS

FIG. 1A is a perspective view of an air conditioning machine.

FIG. 1B is a top plan view of the air conditioning machine of FIG. 1A.

FIG. 2 is a perspective view of the air conditioning machine backbone.

FIG. 3A is a first perspective view of a forward manifold.

FIG. 3B is a second perspective view of the forward manifold of FIG. 3A.

FIG. 3C is a front elevation view of the forward manifold of FIG. 3A.

### DETAILED DESCRIPTION

In general, the present invention relates to an air conditioning machine for an aircraft. The air conditioning machine is supported by an air conditioning machine backbone, which can withstand the loads and stresses that are put on the air conditioning machine.

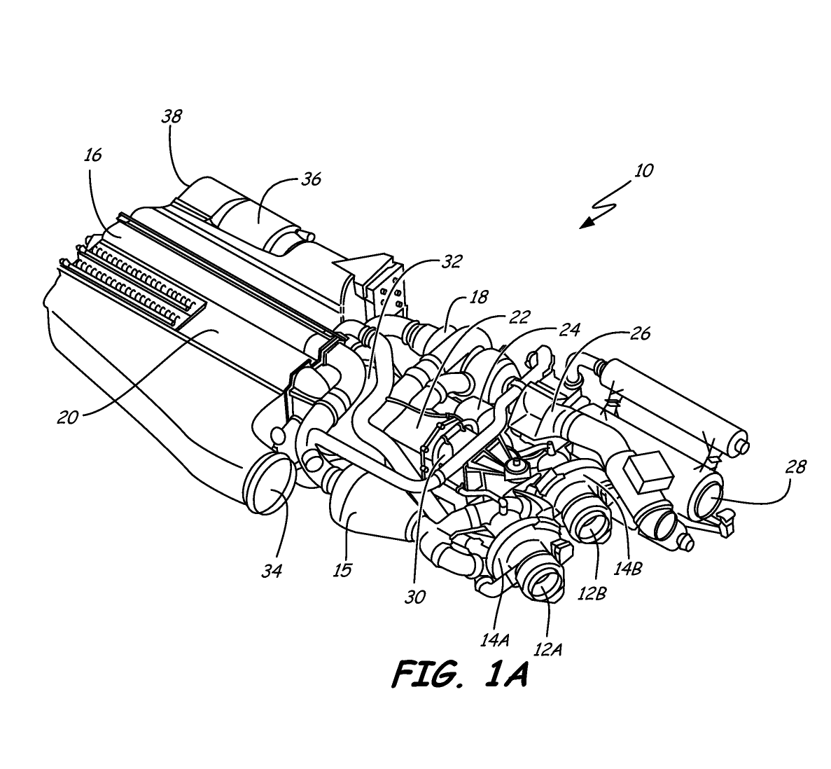

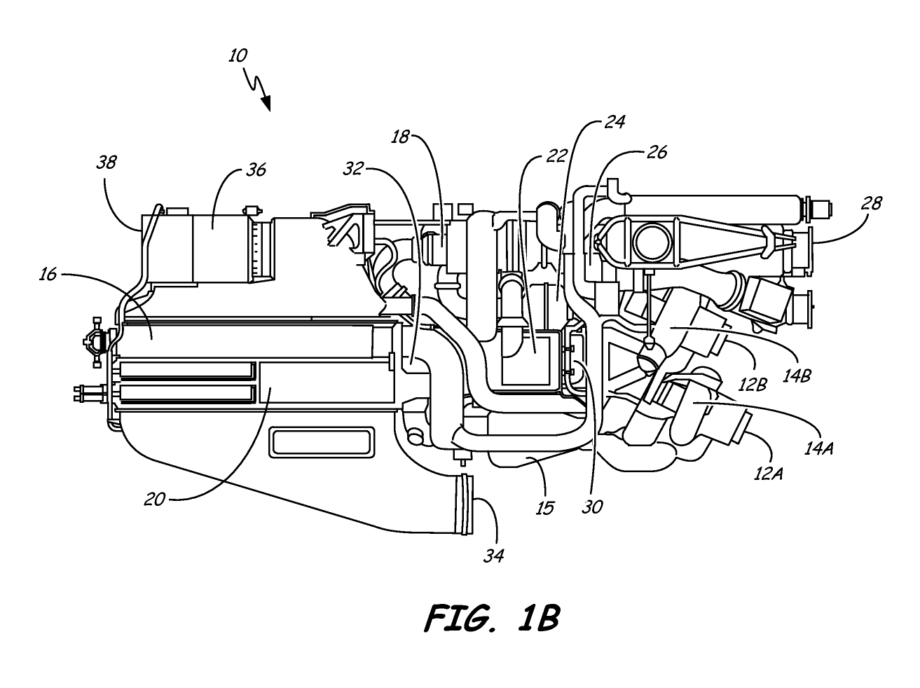

FIG. 1A is a perspective view of air conditioning machine 10. FIG. 1B is a top plan view of air conditioning machine 10. Air conditioning machine 10 includes two ambient air inlets 12A and 12B, two air compressors 14A and 14B, ozone converter 15, primary heat exchanger 16, air cycle machine 18, secondary heat exchanger 20, condenser 22, water collector 24, recirculation mixer 26, outlet 28, forward manifold 30, aft manifold 32, ram air inlet 34, ram air fan 36, and ram air outlet 38. Secondary heat exchanger 20 is attached to ram air inlet 34 and primary heat exchanger 16. Primary heat exchanger 16 is attached to ram air fan 36 and ram air outlet 38. Primary heat exchanger 16 and secondary heat exchanger 20 are further attached to aft manifold 32. Aft manifold 32 is attached to a back end of condenser 22, and forward manifold 30 is attached to a front end of condenser 22. Forward manifold 30 is attached by a duct to water collector 24. Air cycle machine 18 is attached by a duct to primary heat exchanger 16 and secondary heat exchanger 20 and is connected to recirculation mixer 26. Outlet 28 is attached to recirculation mixer 26.

Air conditioning machine 10 can be mounted to a pressure vessel of an aircraft and works to supply conditioned air to the aircraft cabin at the proper temperature and pressure. Ambient air is ingested through an opening on the aircraft and travels through a duct (not shown) to ambient air inlets 12A and 12B and to ram air inlet 34. The air that flows through ram air inlet 34 flows through ram air fan 36 and out of ram air outlet 38. The air in ram air fan 36 is used to cool the air flowing through primary heat exchanger 16 and secondary heat exchanger 20.

The air that flows through ambient air inlets 12A and 12B flows into air compressors 14A and 14B, respectively. Air compressors 14A and 14B compress ambient air, which then flows through ozone converter 15 to primary heat exchanger 16. Primary heat exchanger 16 cools the compressed air using the cooling airflow from ram air fan 36. The cooled air then flows to air cycle machine 18 where it is further compressed. The compressed air from air cycle machine 18 then flows to secondary heat exchanger 20 where it is further cooled using ram air fan 36.

The cooled air from secondary heat exchanger 20 then flows through a duct to forward manifold 30, which is connected to condenser 22. Condenser 22 condenses the cooled air by lowering the air temperature. The condensed air then flows back through forward manifold 30 to water collector 24, which collects the condensed water out of the airflow. The air then flows from water collector 24 to recirculation mixer 26. Recirculation mixer 26 mixes the cooled air with recirculated air from the aircraft cabin. Recirculation mixer 26 is connected to outlet 28, which expels the mixed air into the aircraft cabin.

Air conditioning machine 10 has high loads and stresses put on it from the weight and movement of the aircraft. Air conditioning machine 10 needs a central support that can withstand the loads and stresses that are put on it. Stresses transferred to air conditioning machine 10 from the aircraft include stresses from take-off, landing, and turbulence, and stresses from extreme temperatures. To support the loads and stresses being placed on it, air conditioning machine 10 is centrally supported by aft manifold 32, condenser 22, and forward manifold 30.

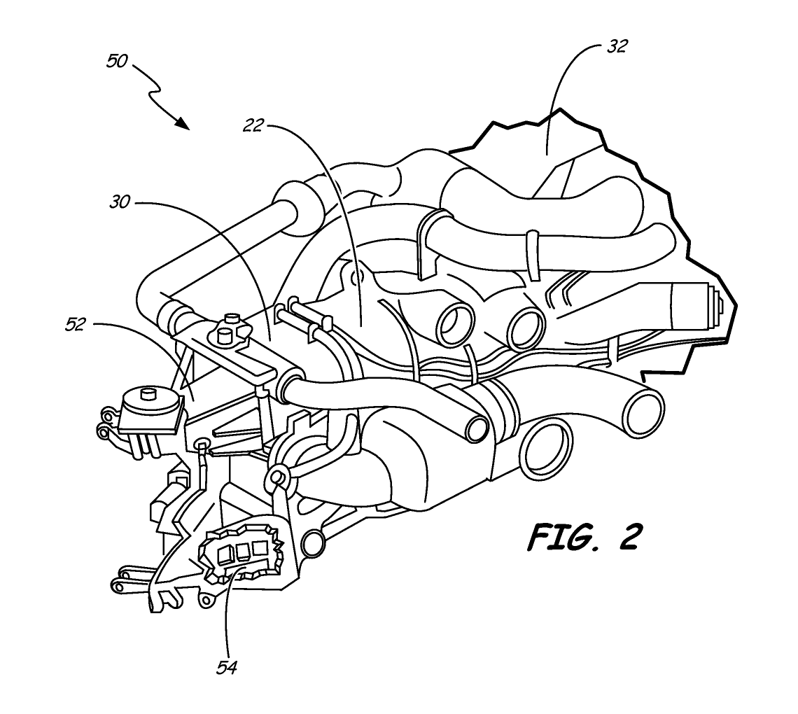

FIG. 2 is a perspective view of air conditioning machine backbone 50. Air conditioning machine backbone 50 includes aft manifold 32, condenser 22, forward manifold 30, top mount 52, and bottom mount 54. A front end of condenser 22 is attached to a back end of forward manifold 30 and a back end of condenser 22 is attached to a front end of aft manifold 32. Forward manifold 30 and aft manifold 32 are bolted to condenser 22 in the embodiment shown, but forward manifold 30 and aft manifold 32 can be attached to condenser 22 with the use of any suitable fastener. A front end of forward manifold 30 is attached to top mount 52 and bottom mount 54. Top mount 52 and bottom mount 54 are bolted to forward manifold 30 in the embodiment shown, but top mount 52 and bottom mount 54 can be attached to forward manifold 30 with the use of any suitable fastener.

Air conditioning machine backbone 50 is used to support air conditioning machine 10. Air conditioning machine 10 experiences stress due to the movement of the airplane. Stresses put on air conditioning machine 10 include stresses from take-off, landing, and turbulence, stresses from the weight of the aircraft, and stresses from the extreme temperatures the aircraft has to endure. To support these stresses, air conditioning machine backbone 50 has to be built to withstand particular load, temperature, stiffness, and vibrational requirements. Air conditioning machine backbone 50 has to be stiff in some areas to withstand the high loads placed on it, but it also has to be flexible in areas to withstand the movement of the aircraft during take-off and landing. To prevent wearing out and failure of air conditioning machine backbone 50, each part must be carefully designed to be flexible in some areas while stiff in others. Further, each part must be carefully designed to absorb vibrational stresses and to withstand the high loads and extreme temperatures that air conditioning machine backbone 50 has to endure.

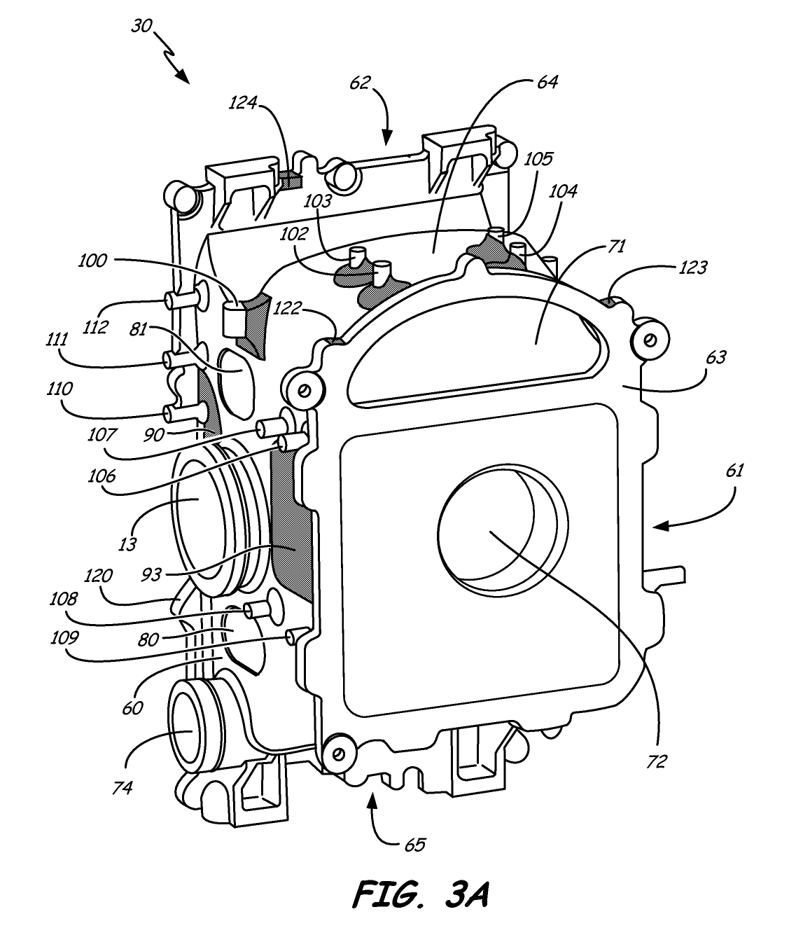

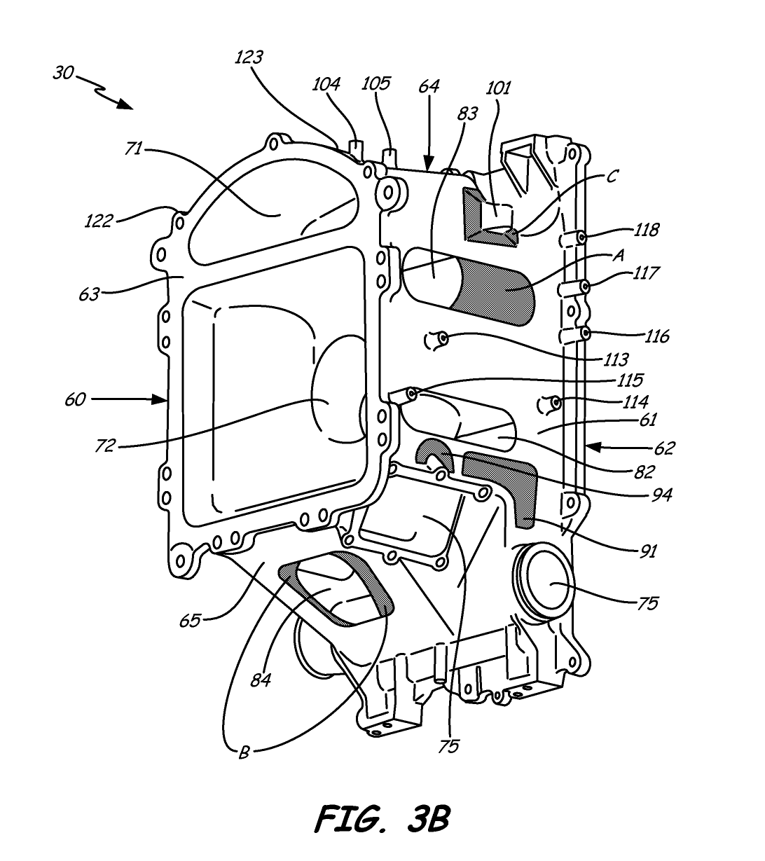

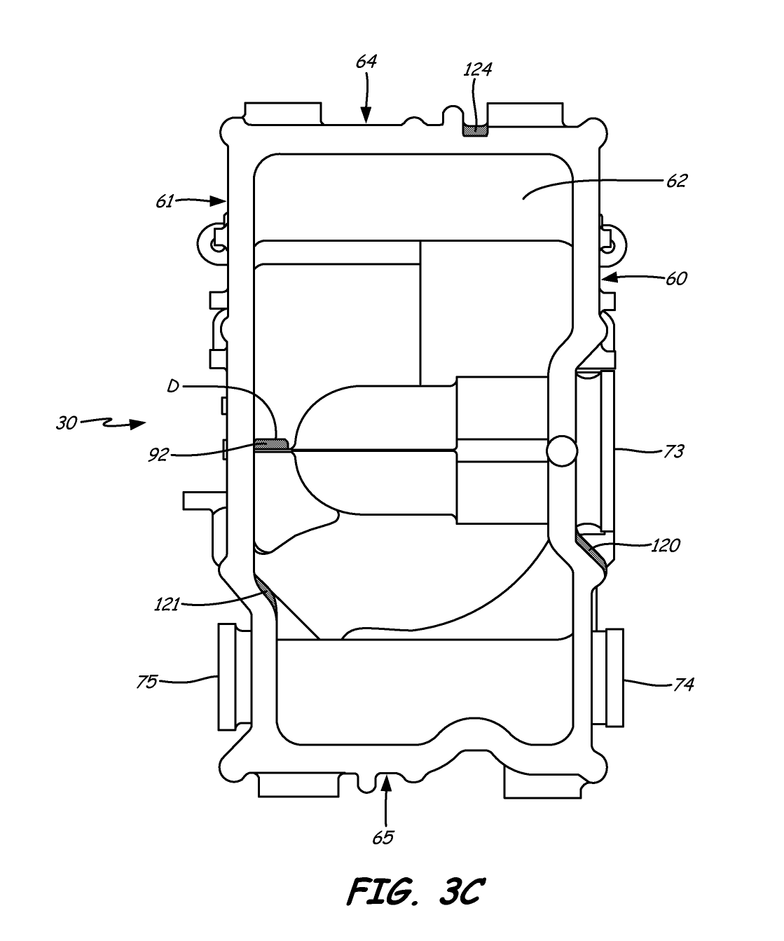

FIG. 3A is a first perspective view of forward manifold 30. FIG. 3B is a second perspective view of forward manifold 30. FIG. 3C is a front elevation view of forward manifold 30. Forward manifold 30 has first sidewall 60, second sidewall 61, first end mounting face 62, second end mounting face 63, top sidewall 64, and bottom sidewall 65. Forward manifold 30 has an internal structure that defines a first plenum, a second plenum, and a duct. The internal structure of forward manifold 30 has walls with a thickness between 0.71 cm (0.110 in.) and 0.87 cm (0.135 in.). The first plenum has first inlet 70 and first outlet 71. The second plenum has second inlet 72 and second outlet 73. The duct has third inlet 74 and third outlet 75. Forward manifold 30 further includes windows 80, 81, 82, 83, and 84; doublers 90, 91, 92, 93 and 94; lugs 100, 101, 102, 103, 104, 105, 106, 107, 108, 109, 110, 111, 112, 113, 114, 115, 116, 117, and 118; and flanges 120, 121, 122, 123, and 124.

First inlet 70 is on second sidewall 61 of forward manifold 30. First inlet 70 is connected to a duct that receives air from secondary heat exchanger 20. First inlet 70 is rectangular in shape with a width of about 8.889 centimeters (cm) (3.5 inches) and a height of about 13.97 cm (5.5 inches). First outlet 71 is on second end mounting face 63 of forward manifold 30. First outlet 71 is connected to condenser 22. First outlet 71 has a semi-circle shape with the largest width being about 27.94 cm (11 inches) and the largest height being about 9.69 cm (3.82 inches). First inlet 70 receives air into the first plenum and first outlet 71 expels air from the first plenum.

Second inlet 72 is on second end mounting face 63 of forward manifold 30. Second inlet 72 is connected to condenser 22. Second inlet 72 is rectangular in shape with a width of about 30.157 cm (11.873 inches) and a height of about 28.448 cm (11.2 inches). Second outlet 73 is on first sidewall 60 of forward manifold 30. Second outlet 73 is connected to a duct that sends air to water collector 24. Second outlet 73 is circular in shape with a diameter of about 11.532 cm (4.54 inches). Second inlet 72 receives air into the second plenum and second outlet 73 expels air from the second plenum.

Third inlet 74 is on first sidewall 60 of forward manifold 30. Third inlet 74 is connected to a duct that receives exhaust from air compressors 14A and 14B. Third inlet 74 is circular in shape with a diameter of about 6.807 cm (2.68 inches). Third outlet 75 is on second sidewall 61 of forward manifold 30. Third outlet 75 is connected to a duct that sends exhaust to ram air fan 36. Third outlet 75 is circular in shape with a diameter of about 6.807 cm (2.68 inches). Third inlet 74 receives exhaust into the duct and third outlet 75 expels the exhaust from the duct.

Forward manifold 30 has windows 80, 81, 82, 83, and 84. Window 80 and window 81 are on first sidewall 60 of forward manifold 30. Window 80 is located between third inlet 74 and second outlet 73. Window 80 is rectangular in shape with a width of about 5.715 cm (2.25 inches) and a height of about 10.16 cm (4 inches). Window 80 occupies an area of about 51.05 cm² (7.913 inches²) in first sidewall 60. Window 81 is located above second outlet 73 and below lug 100. Window 81 is rectangular in shape with a width of about 6.35 cm (2.5 inches) and a height of about 8.889 cm (3.5 inches). Window 81 occupies an area of about 47.80 cm² (7.409 inches²) in first sidewall 60. Window 82 and window 83 are on second sidewall 61 of forward manifold 30. Window 82 is located above doubles 94 and 91 and below window 83. Window 82 is rectangular in shape with a width of about 5.08 cm (2 inches) and a height of about 18.923 cm (7.450 inches). Window 82 occupies an area of about 90.40 cm² (14.012 inches²) in second sidewall 61. Window 83 is located below lug 101 and above window 82. Window 83 is rectangular in shape with a width of about 6.35 cm (2.5 inches) and a height of about 8.889 cm (3.5 inches). Window 83 occupies an area of about 47.55 cm² (7.371 inches²) in second sidewall 61. Window 84 is on bottom sidewall 65 and is located off center closer to first sidewall 60. Window 84 is rectangular in shape with a width of about 8.889 cm (3.5 inches) and a height of about 12.387 cm (4.877 inches). Window 84 occupies an area of about 100.74 cm² (15.615 inches²) in bottom sidewall 65.

Windows 80, 81, 82, 83, and 84 help to reduce the overall weight of forward manifold 30. Windows 80, 81, 82, 83, and 84 also provide the proper levels of stiffness needed in forward manifold 30. The size of windows 80, 83, and 84 were reduced compared to the prior art. This provides more stiffness for forward manifold 30 to withstand the stresses being placed on it. Window 84 was also shifted closer to first sidewall 60 by about 1.27 cm (0.5 inches) compared to the prior art. Shifting window 84 affects the flexibility and stiffness of bottom sidewall 65 in different areas to withstand the stresses that are seen in those areas.

Forward manifold 30 also has doublers 90, 91, 92, 93, and 94. Doubler 90 is on first sidewall 60 between second outlet 73 and window 81. Doubler 90 occupies an area of about 30.86 cm² (4.784 inches²) on first sidewall 60. Doubler 90 has a thickness of about 1.044 cm (0.411 inches). Doubler 91 is on second sidewall 62 below window 82 and above third outlet 75. Doubler 91 occupies an area of about 72.30 cm² (11.207 inches²) on second sidewall 62. Doubler 91 has a thickness of about 0.66 cm (0.26 inches). Doubler 92 is on first end mounting face 62 and is located next to second sidewall 61 on a strut running between second sidewall 61 and first sidewall 60. Doubler 92 occupies an area of about 5.23 cm² (0.811 inches²) on first end mounting face 62. Doubler 92 has a thickness of about 1.041 cm (0.41 inches). Doubler 93 is on first sidewall 60 and is located next to second outlet 73, above lugs 108 and 109 and below lugs 106 and 107. Doubler 93 occupies an area of about 145.27 cm² (22.517 inches²) on first sidewall 60. Doubler 93 has a thickness of about 0.422 cm (0.166 inches). Doubler 94 is on second sidewall 62 and is located below window 82 and above first inlet 70. Doubler 94 occupies an area of about 10.45 cm² (1.620 inches²) on second sidewall 62. Doubler 94 has a thickness of about 0.406 cm (0.160 inches).

Doublers 90, 91, 92, 93, and 94 are located on forward manifold 30 to increase the stiffness of forward manifold 30. As previously stated, forward manifold 30 has to withstand large loads and stresses. These loads and stresses cause forward manifold 30 to twist. Compared to the prior art, doublers 90 and 92 are added and the thickness of doubler 91 is increased in order to increase the stiffness of forward manifold 30 in these areas. This reduces the amount of twist seen in these areas. Increasing the stiffness of forward manifold 30 in these areas can decrease the wear in these areas, ensuring that forward manifold 30 has a smaller risk of failure.

Forward manifold 30 also includes lugs 100-118. Lug 100 is on first sidewall 60, is located above window 81, and has a fillet radius of about 1.905 cm (0.75 inches). Lug 101 is on second sidewall 61, is located above window 83, and has a fillet radius of about 1.905 cm (0.75 inches). Lugs 102, 103, 104 and 105 are on top sidewall 64 and are located in a square shape relative to each other, each lug defining a corner. Lugs 102, 103, 104, and 105 each have a fillet radius of about 1.905 cm (0.75 inches). Lugs 106, 107, 108, and 109 are on first sidewall 60 and have a fillet radius of about 0.952 cm (0.38 inches). Lugs 106 and 107 are located above doubler 93 and lugs 108 and 109 are located below doubler 93. Lugs 110, 111, and 112 are on first sidewall 60 and have a fillet radius of about 0.635 cm (0.25 inches). Lugs 110, 111, and 112 are located along an edge of first sidewall 60 that connects to first end mounting face 62. Lugs 113, 114, and 115 are on second sidewall 61 and have a fillet radius of about 0.952 cm (0.375 inches). Lug 113 is located below window 83, lug 114 is located above window 82, and lug 115 is located beside window 82. Lugs 116, 117, and 118 are on second sidewall 61 and have a fillet radius of about 0.635 cm (0.25 inches). Lugs 116, 117, and 118 are located along an edge of second sidewall 61 that connects to first end mounting face 62.

Lugs 100-118 are included on forward manifold 30 as transitions for attaching forward manifold 30 to other components in air conditioning machine 10. Lugs 100, 101, 102, 103, 104, and 105 each have a fillet radius that has been increased compared to the prior art. The fillet radii of lugs 100, 101, 102, 103, 104, and 105 were increased to withstand higher vibrational forces in forward manifold 30.

Forward manifold 30 also includes flanges 120, 121, 122, 123, and 124. Flange 120 is on first end mounting face 62 and is located on an edge of first end mounting face 62 that connects to first sidewall 60. Flange 120 has a radius of about 2.54 cm (1 inches). Flange 121 is on first end mounting face 62 and is located on an edge of first end mounting face 62 that connects to second sidewall 61. Flange 121 has a radius of about 1.905 cm (0.75 inches). Flange 122 is on second end mounting face 63 and is located at a corner of second end mounting face 63 that connects to first sidewall 60 and top sidewall 64. Flange 122 has a radius of about 0.635 cm (0.25 inches). Flange 123 is on second end mounting face 63 and is located at a corner of second end mounting face 63 that connects to second sidewall 60 and top sidewall 64. Flange 123 has a radius of about 0.635 cm (0.25 inches). Flange 124 is on first end mounting face 62 and is located on an edge of first end mounting face 62 that connects to top sidewall 64. Flange 124 has a radius of about 1.27 cm (0.5 inches).

Flanges 120, 121, 122, 123, and 124 have a radius that is increased compared to the prior art. The radii are increased to withstand the vibrational stresses that are being placed on forward manifold 30. The vibrational stresses that are placed on forward manifold 30 come from the movement of the aircraft and the loads and temperatures that forward manifold 30 has to withstand.

Forward manifold 30 is machined, although any suitable production method could be used. Forward manifold 30 is preferably made of aluminum, although any material that is capable of withstanding high temperatures and stresses is suitable.

Forward manifold 30 is located in air conditioning machine 10 to provide structure and support for air conditioning machine 10. Forward manifold 30 is designed to specific parameters to withstand the extreme temperatures, loads, and stresses put on it. Forward manifold 30 is bolted to components of air conditioning machine 10 to hold the different components together. Forward manifold 30 also has plenums and ducts to transfer air and exhaust from one location in air conditioning machine 10 to another location. Forward manifold 30 is designed to withstand the loads, temperatures, and stresses being placed on it while being as low weight as possible at the same time.

Windows 80-84, doublers 90-94, lugs 100-118, and flange 120-124 are specifically designed to minimize the weight of forward manifold 30 while providing the structure needed to support the loads, temperatures, and pressures being put on it. Windows 80-84 are shaped and positioned to provide the proper level of stiffness needed in forward manifold 30 while reducing the weight of forward manifold 30. Doublers 90-94 are shaped and positioned to strengthen the sidewalls of forward manifold 30 in areas where high stresses are seen. Doublers 90-94 help to ensure that these areas do not wear out and fail. Lugs 100-118 have fillet radii that are sized and shaped to absorb some of the vibrational stresses that are put on forward manifold 30. The increased fillet radii also help strengthen lugs 100-118 for attachment to other components in aircraft air conditioning machine 10. The radii of flanges 120-124 are sized and shaped to increase the strength of the flange and to absorb vibrational stresses. All together, the shape, position, and size of windows 80-84, doublers 90-94, lugs 100-118, and flange 120-124 ensure that forward manifold 30 can support the loads, temperatures, and stresses being placed on it.

A method is also provided to install forward manifold 30 in air conditioning machine 10. The method comprises the steps of bolting forward manifold 30 to condenser 22, bolting two mounts 52 and 54 to forward manifold 30, orientating backbone 50 in air conditioning machine 10, and bolting other components of air conditioning machine 10 to backbone 50.

First, forward manifold 30 is bolted to condenser 22. Forward manifold 30 is attached to condenser 22 at a second end mounting face of forward manifold 30 and to a first end mounting face of condenser 22. Forward manifold 30 is bolted to condenser 22 in the embodiment shown, although forward manifold 30 and condenser 22 can be attached using any suitable fastener. A second end mounting face of condenser 22 is also bolted to a first end mounting face of aft manifold 32.

Second, top mount 52 and bottom mount 54 are bolted to forward manifold 30. Top mount 52 is bolted to first end mounting face 62 of forward manifold 30 closer to top sidewall 64 of forward manifold 30, and bottom mount 54 is bolted to first end mounting face 62 closer to bottom sidewall 65 of forward manifold 30. Top mount 52 and bottom mount 54 are bolted to forward manifold 30 in the embodiment shown, but they can be attached using any suitable fastener.

Third, air conditioning machine backbone 50 is oriented in air conditioning machine 10. Air conditioning machine backbone 50 is oriented with top mount 52 and bottom mount 54 in a forward position and aft manifold 32 in the aft position. Top mount 52 is oriented above bottom mount 54, placing the top sidewall of forward manifold 30, condenser 22, and aft manifold 32 above the bottom sidewall of the same.

Fourth, other components of air conditioning machine 10 are bolted to air conditioning machine backbone 50. A duct coming from secondary heat exchanger 20 is connected to an inlet in forward manifold 30. A duct leading to water extractor 24 is connected to an outlet in forward manifold 30. Further, other components of air conditioning machine 10 are bolted to forward manifold 30 on the top sidewall, bottom sidewall, first sidewall, and second sidewall. Air conditioning machine backbone 50 provides structure to air conditioning machine 10, as air conditioning machine 10 is built up around backbone 50.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A manifold for an air conditioning machine, the manifold comprising:
a housing having an internal structure defining a first plenum, a second plenum, and a duct, the housing comprising:
a first sidewall;
a second sidewall;
a first end mounting face;
a second end mounting face;
a top sidewall; and
a bottom sidewall;
a first inlet on the second sidewall to receive air into the first plenum;
a first outlet on the second end mounting face to expel air from the first plenum;
a second inlet on the second end mounting face to receive air into the second plenum;
a second outlet on the first sidewall to expel air from the second plenum;
a third inlet on the first sidewall to receive exhaust into the duct;
a third outlet on the second sidewall to expel exhaust from the duct;
a first and second window in the first sidewall occupying an area of 98.85 square cm (15.332 square inches);
a third and fourth window in the second sidewall occupying an area of 137.95 square cm (21.383 square inches); and
a fifth window on the bottom sidewall occupying an area of 100.74 square cm (15.615 square inches).

2. The manifold of claim 1, wherein the first inlet is rectangular in shape with a width of 8.889 cm (3.5 inches) and a height of 13.97 cm (5.5 inches) and the first outlet has the shape of a semi-circle with a width of 27.94 cm (11 inches) and a height of 9.69 cm (3.815 inches).

3. A manifold for an air conditioning machine, the manifold comprising:
a housing having an internal structure defining a first plenum, a second plenum, and a duct, the housing comprising:
a first sidewall;
a second sidewall;
a first end mounting face;
a second end mounting face;
a top sidewall; and
a bottom sidewall;
a first inlet on the second sidewall to receive air into the first plenum;
a first outlet on the second end mounting face to expel air from the first plenum;
a second inlet on the second end mounting face to receive air into the second plenum;
a second outlet on the first sidewall to expel air from the second plenum;
a third inlet on the first sidewall to receive exhaust into the duct;
a third outlet on the second sidewall to expel exhaust from the duct;
a first and second doubler on the first sidewall occupying an area of 176.13 cm² (27.301 inches²);
a third and fourth doubler on the second sidewall occupying an area of 82.75 cm² (12.827 inches²); and
a fifth doubler on the first end mounting face occupying an area of 5.23 cm² (0.811 inches²).

4. A manifold for an air conditioning machine, the manifold comprising:
a housing having an internal structure defining a first plenum, a second plenum, and a duct, the housing comprising:
a first sidewall;
a second sidewall;
a first end mounting face;
a second end mounting face;
a top sidewall; and
a bottom sidewall;
a first inlet on the second sidewall to receive air into the first plenum;
a first outlet on the second end mounting face to expel air from the first plenum;
a second inlet on the second end mounting face to receive air into the second plenum;
a second outlet on the first sidewall to expel air from the second plenum;
a third inlet on the first sidewall to receive exhaust into the duct;
a third outlet on the second sidewall to expel exhaust from the duct;
a first lug on the first sidewall with a fillet radius of 1.905 cm (0.75 inches);
a second lug on the second sidewall with a fillet radius of 1.905 cm (0.75 inches); and
a plurality of lugs on the top sidewall each with a fillet radius of 1.905 cm (0.75 inches).

5. The manifold of claim 4, wherein the first lug occupies an area next to the top sidewall between the first end mounting face and second end mounting face.

6. The manifold of claim 4, wherein the second lug occupies an area next to the top sidewall between the first end mounting face and second end mounting face.

7. The manifold of claim 4, wherein the plurality of lugs includes four lugs arranged in a square pattern and occupying a space next to the second end mounting face.

8. A manifold for an air conditioning machine, the manifold comprising:
a housing having an internal structure defining a first plenum, a second plenum, and a duct, the housing comprising:
a first sidewall;
a second sidewall;
a first end mounting face;
a second end mounting face;
a top sidewall; and
a bottom sidewall;
a first inlet on the second sidewall to receive air into the first plenum;
a first outlet on the second end mounting face to expel air from the first plenum;
a second inlet on the second end mounting face to receive air into the second plenum;
a second outlet on the first sidewall to expel air from the second plenum;
a third inlet on the first sidewall to receive exhaust into the duct;
a third outlet on the second sidewall to expel exhaust from the duct;
a first flange on the first end mounting face with a radius of 2.54 cm (1 inches);
a second flange on the first end mounting face with a radius of 1.905 cm (0.75 inches);
a third flange on the first end mounting face with a radius of 1.27 cm (0.5 inches); and
a fourth and fifth flange on the second end mounting face each with a radius of 0.635 cm (0.25 inches).

9. A manifold for an air conditioning machine, the manifold comprising:
a housing having an internal structure defining a first plenum, a second plenum, and a duct, the housing comprising:
a first sidewall;
a second sidewall;
a first end mounting face;
a second end mounting face;
a top sidewall; and
a bottom sidewall;
a first inlet on the second sidewall to receive air into the first plenum;
a first outlet on the second end mounting face to expel air from the first plenum;
a second inlet on the second end mounting face to receive air into the second plenum;
a second outlet on the first sidewall to expel air from the second plenum;
a third inlet on the first sidewall to receive exhaust into the duct;
a third outlet on the second sidewall to expel exhaust from the duct;
a first window on the first sidewall occupying an area of 51.05 cm² (7.913 inches²);
a second window on the second sidewall occupying an area of 47.80 cm² (7.409 inches²);
a third window on the bottom sidewall occupying an area of 100.74 cm² (15.615 inches²);
a first doubler on the first sidewall occupying an area of 30.86 cm² (4.784 inches²);
a second doubler on the second sidewall having a thickness of 0.66 cm (0.26 inches);
a third doubler on the first end mounting face occupying an area of 5.23 cm² (0.811 inches²);
a first lug on the first sidewall with a fillet radius of 1.905 cm (0.75 inches);
a second lug on the second sidewall with a fillet radius of 1.905 cm (0.75 inches);
a plurality of lugs on the top sidewall each with a fillet radius of 1.905 cm (0.75 inches);
a first flange on the first end mounting face with a radius of 2.54 cm (1 inches);
a second flange on the first end mounting face with a radius of 1.905 cm (0.75 inches);
a third flange on the first end mounting face with a radius of 1.27 cm (0.5 inches); and
a fourth and fifth flange on the second end mounting face each with a radius of 0.635 cm (0.25 inches).

10. The manifold of claim 9, wherein the second inlet is rectangular in shape with a width of 30.157 cm (11.873 inches) and a height of 28.448 cm (11.2 inches) and the second outlet is circular in shape with a diameter of 11.532 cm (4.54 inches).

11. The manifold of claim 9, wherein the third inlet is circular in shape with a diameter of 6.807 cm (2.68 inches) and the third outlet is circular in shape with a diameter of 6.807 cm (2.68 inches).

12. The manifold of claim 9, wherein inner walls of the manifold have a thickness between 0.71 cm (0.110 in.) and 0.87 cm (0.135 in.).

13. The manifold of claim 9, wherein the first window occupies a space between the third inlet and the second outlet.

14. The manifold of claim 9, wherein the second window occupies a space above the fourth window and below the top sidewall.

15. The manifold of claim 9, wherein the third window occupies a space between the first end mounting face and the second end mounting space.

16. The manifold of claim 9, wherein the first doubler occupies an area above the second outlet and next to the first end mounting face.

17. The manifold of claim 9, wherein the second doubler occupies an area above the first inlet and third outlet and next to the first end mounting face.

18. The manifold of claim 9, wherein the third doubler occupies an area between the top sidewall and bottom sidewall and next to the second sidewall.

19. An aircraft air conditioning machine comprising:
a plurality of air inlets to receive air into the system;
a plurality of compressors to compress the air;
a primary heat exchanger to receive and cool compressed air from the compressors;
an air cycle machine to receive cooled air from the primary heat exchanger and to further compress the cooled air;
a secondary heat exchanger to receive and cool compressed air from the air cycle machine;
a condenser to receive cooled air from the secondary heat exchanger and remove condensed water vapor;
a recirculation mixer to mix recirculated air from an aircraft cabin with cooled air from the condenser;
a forward manifold comprising:
a first sidewall with an outlet of a second plenum connecting to a water collector, an inlet of a third plenum to receive exhaust from a cabin air compressor, a window occupying an area of 51.05 cm² (7.913 inches²), a doubler occupying an area of 30.86 cm² (4.784 inches²), and a lug with a fillet radius of 1.905 cm (0.75 inches);
a second sidewall with an outlet of a third plenum connecting to a fan inlet diffuser housing, an inlet of a first plenum to receive air from a secondary heat exchanger, a window occupying an area of 47.80 cm² (7.409 inches²), a doubler with a thickness of 0.66 cm (0.26 inches), and a lug with a fillet radius of 1.905 cm (0.75 inches);
a first end mounting face with a doubler occupying an area of 5.23 cm² (0.811 inches²), a first flange with a radius of 2.54 cm (1 inches), a second flange with a radius of 1.905 cm (0.75 inches), and a third flange with a radius of 1.27 cm (0.5 inches);
a second end mounting face with an outlet of a first plenum connecting to a condenser, an inlet of a second plenum to receive air from the condenser, and a plurality of flanges each with a radius of 0.635 cm (0.25 inches);
a top sidewall with a plurality of lugs each with a fillet radius of 1.905 cm (0.75 inches); and
a bottom sidewall with a window occupying an area of 100.74 cm² (15.615 inches²); and
an outlet to provide mixed air to the aircraft cabin as conditioned air.

20. A method for installing a forward manifold in a backbone assembly for an aircraft conditioning machine with an aft manifold, a condenser, a forward manifold, and two mounts, the method comprising the steps of:
bolting the forward manifold to the condenser using fasteners, wherein the forward manifold comprises a first plenum, a second plenum, a third plenum, a plurality of windows, a plurality of doublers, a plurality of lugs, and a plurality of flanges;
bolting two mounts to the forward manifold using fasteners;
orienting the backbone assembly in the air conditioning machine; and
bolting components of the air conditioning machine to the backbone assembly.
